(19) United States
(12) Patent Application Publication
(10) Pub. No.: US 2025/0355418 A1
(43) Pub. Date: Nov. 20, 2025

(54) NUMERICAL CONTROL APPARATUS

(71) Applicant: FANUC CORPORATION, Yamanashi (JP)

(72) Inventor: Taku YAMAMOTO, Yamanashi (JP)

(73) Assignee: FANUC CORPORATION, Yamanashi (JP)

(21) Appl. No.: 18/291,839

(22) PCT Filed: Aug. 5, 2021
(86) PCT No.: PCT/JP2021/029140

§ 371 Date: Dec. 19, 2024

(51) Int. Cl. G05B 19/4093; G05B 19/4155

(52) U.S. Cl. CPC G05B 19/4093; G05B 19/4155; G05B 2219/36284; G05B 2219/36342

(57) ABSTRACT

The numerical control apparatus according to the present disclosure is capable of easily modifying processing conditions, and controls a processing device on the basis of a processing program including at least one condition command designating processing conditions and a plurality of movement commands designating processing points, the numerical control apparatus comprising: a program storage unit for storing the processing program; a route-deriving unit for deriving from the processing program a plurality of processing routes that connect the processing points; a condition-specifying unit for specifying from the processing program the condition commands designating the processing conditions to be applied to each of the processing routes; a route selection unit for providing a user interface to make the processing routes selectable; and a condition modification unit for providing a user interface to make the processing conditions applied to the processing route selected by the route selection unit modifiable.

### TECHNICAL FIELD

The present invention relates to a numerical control apparatus.

### BACKGROUND ART

For example, machining devices that machine workpieces by moving a machining head, such as a laser head emitting laser light or a rotary toolhead equipped with rotary tools, relative to the workpieces are widely used. In general, the operation of such machining devices is controlled by a numerical control apparatus, based on a machining program containing a plurality of movement commands specifying the machining points where the machining head should pass through. The machining program may also include condition commands specifying machining conditions such as laser output, rotation speed of rotary tools, and distance between the machining head and workpiece.

In the machining program, condition commands may be described as command statements that refer to information stored in a reference table or database that stores a plurality of machining conditions (see, for example, Patent Document 1). As a result, a plurality of types of machining steps, such as cutting an outer circumference and adding decorative shapes to an internal surface, can be easily described in a single machining program, and appropriate machining conditions can be easily applied to each machining step.

### CITATION LIST

### Patent Document

Patent Document 1: PCT International Publication No. WO 2019/189212A1

### DISCLOSURE OF THE INVENTION

### Problems to be Solved by the Invention

In the case of machining using a machining program that includes condition commands and movement commands, there may be situations where it is desirable to modify the machining conditions for certain machining steps. For example, upon actual inspection of a machined workpiece, one might consider changing the machining conditions for a machining step that has produced a portion having inadequate machining quality. In such cases, conventional numerical control programs require the task of identifying the movement command for the machining step having the machining conditions that should be modified, searching for the preceding condition command nearest to the movement command, and rewriting the condition command thus found. Therefore, there has been a need for a technology that allows for easy modification of machining conditions.

### Means for Solving the Problems

The numerical control apparatus according to an aspect of the present disclosure is a numerical control apparatus that controls a machining device, based on a machining program including at least one condition command specifying a machining condition and a plurality of movement commands specifying machining points, in which the apparatus includes: a program storage unit that stores the machining program; a path derivation unit that derives a plurality of machining paths connecting the machining points, from the machining program; a condition specification unit that specifies the condition command specifying the machining condition applicable to each of the machining paths, from the machining program; a path selection unit that provides a user interface that allows for selecting the machining paths; and a condition modification unit that provides a user interface that allows for modifying the machining condition applicable to the machining paths selected in the path selection unit.

### Effects of the Invention

According to the present disclosure, a numerical control apparatus capable of easily modifying machining conditions can be provided.

### BRIEF DESCRIPTION OF THE DRAWINGS

FIG. 1 is a block diagram illustrating a configuration of a numerical control apparatus according to a first embodiment of the present disclosure;

FIG. 2 is a schematic diagram illustrating an example of a display screen produced by a path selection unit of the numerical control apparatus illustrated in FIG. 1;

FIG. 3 is a schematic diagram illustrating an example of a display screen produced by a condition modification unit of the numerical control apparatus illustrated in FIG. 1; and

FIG. 4 is a block diagram illustrating a configuration of a numerical control apparatus according to a second embodiment of the present disclosure.

### PREFERRED MODE FOR CARRYING OUT THE INVENTION

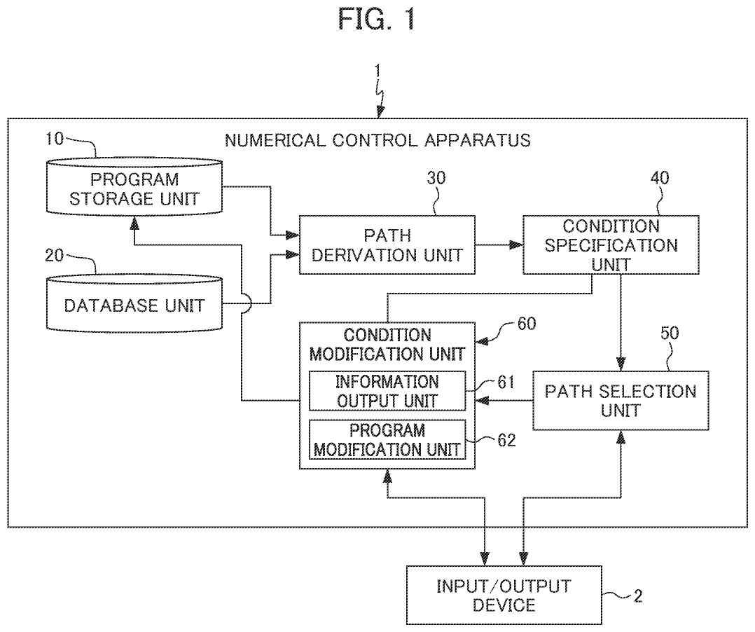

Hereinafter, embodiments of the present disclosure will be described with reference to the drawings. FIG. 1 is a block diagram illustrating a configuration of a numerical control apparatus 1 according to the first embodiment of the present disclosure.

The numerical control apparatus 1 controls a machining device (not illustrated), based on a machining program that includes at least one condition command specifying machining conditions and a plurality of movement commands specifying machining points. Examples of the machining device controlled by the numerical control apparatus 1 may include, for example, a laser machining device that moves a laser head to irradiate a workpiece with laser light, or a machine tool that moves a rotary toolhead relative to a workpiece.

The numerical control apparatus 1 may be implemented by executing an appropriate control program on a computer device equipped with components such as a processor, memory, and input/output interfaces. The numerical control apparatus 1 may optionally include a display device that provides image information to the user, and an input device through which the user can enter information. Input and output may also be carried out via external input/output devices. In the present embodiment, an external input/output device 2 with a display screen is described as being used.

The numerical control apparatus 1 includes a program storage unit 10, a database unit 20, a path derivation unit 30, a condition specification unit 40, a path selection unit 50, and a condition modification unit 60. These components are functional categorizations of the numerical control apparatus 1, and do not necessarily have to be distinctly separable in terms of physical or programmatic configuration.

The program storage unit 10 stores the machining program. The program storage unit 10 may be configured to include a storage area of the memory constituting the numerical control apparatus 1, and program elements that control the writing and reading of the machining program.

The machining program stored in the program storage unit 10 is configured with a plurality of blocks (lines) to be executed in sequence. Each block may be written with a word, which is formed by combining an address specifying the type of command and data specifying the variables associated with the command. For explanatory purposes, a sample program will be presented next.

### <Sample Program>

O001
E001
G01G90X100.
G01G90Y100.
E002
G01G90X200.
G01G90Y200.
E001
G01G90X100.

In the sample program, the address “O” indicates the word specifying a program number, the address “E” indicates the word specifying a machining condition (condition command), and the address “G” indicates the word specifying a movement (movement command). In the sample program, the machining conditions are specified by the record numbers in the database unit 20, respectively. That is, “E001” means that the machining condition in accordance with the data of the record number 001 in the database unit 20 should be applied.

The database unit 20 stores a plurality of records that specify a plurality of machining conditions, respectively. The database unit 20 may be configured to include a memory storage area constituting the numerical control apparatus 1, and program elements that control the writing and reading of the machining conditions.

The data items in the database unit 20 are appropriately set in accordance with the types of machining heads, etc. For example, in the case where the machining head is a laser head, the data items may include feed rate, output, pulse bottom voltage, frequency, duty cycle, assist gas pressure, assist gas type, assist gas supply time, and the gap between the workpiece and the head. Note that the data such as the types of assist gases may be configured to define conditions using reference table numbers that are provided separately.

The path derivation unit 30 derives a plurality of machining paths connecting machining points from the machining program, i.e., derives the paths of the machining head that moves relative to the workpiece. Each machining path can typically represent a single segment for continuously machining. Each block may also be considered a machining path; and a segment to be continuously machined may be divided into a plurality of paths, each of which may also be considered a machining path, based on the criteria such as the number of machining points.

The condition specification unit 40 specifies condition commands that specify the machining conditions applicable to each machining path from the machining program. Specifically, the condition specification unit 40 specifies the position (block number) of the nearest preceding machining command in the machining program for each machining path derived by the path derivation unit 30. Thus, the condition specification unit 40 may be configured to store a table that indicates the correspondence relationship between the machining path and the position of the machining command.

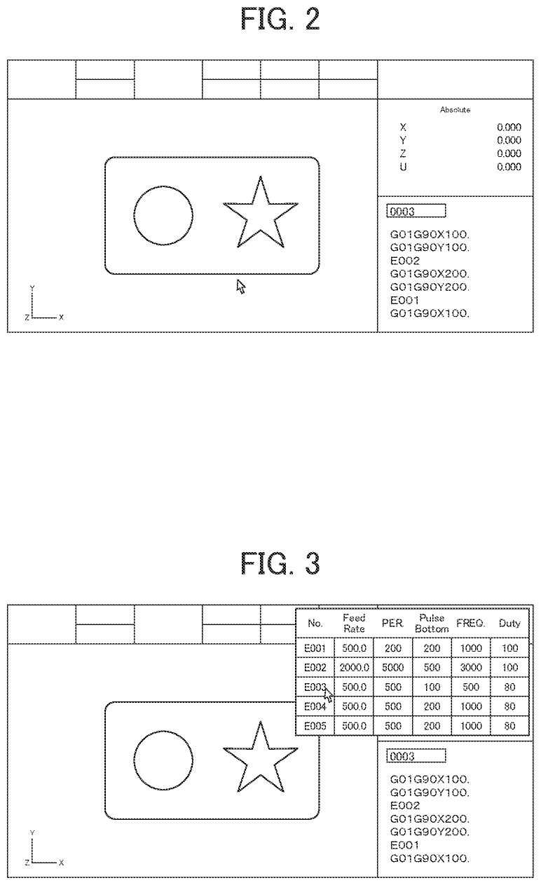

The path selection unit 50 provides a user interface that allows for selecting machining paths. As a method of selecting a machining path via the path selection unit 50, various approaches such as specifying program line numbers or sequence numbers (commonly designated by ‘N’) can be considered. However, preferably, as illustrated in FIG. 2 in particular, an image (preview image) of the machining paths should be displayed on the screen of the input/output device 2, and the machining paths thus displayed should be selectable. The example illustrated in FIG. 2 includes a machining path for cutting a rectangular outer perimeter, a machining path for forming an internal circular decorative groove, and a machining path for forming an internal star-shaped decorative groove. Note that the path selection unit 50 may either directly control the input/output device, or provide machining path information to an independently controlled input/output terminal and retrieve information inputted from the user via the input/output terminal.

The path selection unit 50 may be configured, for example, to receive the input of numbers assigned to the machining paths so as to be selectable. However, the displayed machining paths are preferably directly selectable. Specifically, the path selection unit 50 may be configured to allow for manipulating a cursor on the display screen that displays the machining paths and selecting a machining path. Alternatively, the machining paths may be displayed on a touch panel, allowing for touching the area of the touch panel where a machining path is displayed and selecting the machining path.

The condition modification unit 60 provides a user interface that allows for modifying the machining conditions applicable to the machining path selected by the path selection unit 50. In the present embodiment, the condition modification unit 60 includes an information output unit 61 that outputs information on the machining conditions applicable to the selected path, and a program modification unit 62 that modifies the condition commands in the machining program.

The information output unit 61 may be configured to output information on the machining conditions via audio or the like; however, preferably, the information output unit 61 is configured to display textual information on the display screen of the input/output device 2 where the path selection unit 50 displays the machining paths. More preferably, as illustrated in FIG. 3, in the state where the path selection unit 50 is displaying the machining paths on the input/output device 2, the information output unit 61 is configured to provide a popup display (i.e., an overlaid display) of the information on the machining conditions on the display screen of the input/output device 2 that displays the machining paths. This enables the user to smoothly modify the machining conditions of the machining path as intended.

Examples of the information on the machining conditions outputted by the information output unit 61 may include usable machining commands or variables of machining commands, i.e., record numbers or unique keys existing in the database unit 20. The information output unit 61 preferably outputs at least some of the data of the records existing in the database unit 20, in particular, the key data having a significant impact on the machining result. This allows the user to easily select appropriate condition commands.

The information output unit 61 may also display information so as to receive modifications to the machining commands. For example, the information output unit 61 may be configured to display the data of the condition commands and the machining conditions to be specified thereby, in a selectable list format. Alternatively, the information output unit 61 may display the condition commands in an editable text box.

The program modification unit 62 rewrites the condition commands specifying the machining conditions applicable to the machining path selected by the path selection unit 50 in the machining program stored in the program storage unit 10, to the condition commands as inputted by the user. This results in modification of the machining conditions for all the machining paths where the rewritten condition commands are applicable.

As described above, the numerical control apparatus 1 provides an interface that allows the user to select a machining path on the preview screen of the machining paths and easily modify the machining conditions as they wish, allowing for easily and appropriately modifying the machining conditions.

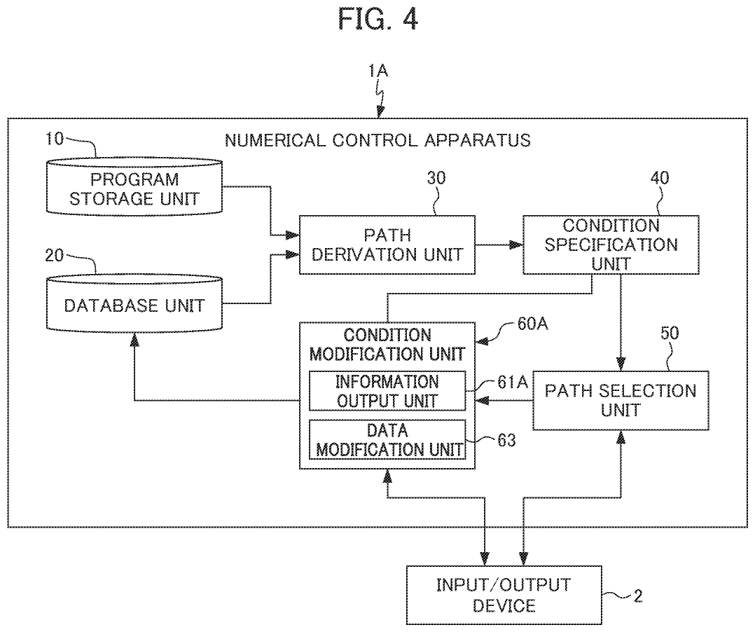

FIG. 4 illustrates a configuration of a numerical control apparatus 1A according to the second embodiment of the present disclosure. In the description of the present embodiment, elements that are the same as those in the previous embodiment are designated by the same symbols, and repetitive descriptions are omitted.

The numerical control apparatus 1A according to the present embodiment includes the program storage unit 10, the database unit 20, the path derivation unit 30, the condition specification unit 40, the path selection unit 50, and a condition modification unit 60A.

The condition modification unit 60A provides a user interface that allows for modifying the machining conditions applicable to the machining path selected by the path selection unit 50. The condition modification unit 60A includes an information output unit 61A that outputs information on the machining conditions applicable to the selected machining path, and a data modification unit 63 that modifies the data of the records applicable to the machining path selected from the database unit 20.

The information output unit 61A provides a popup display or the like to output the data of the records defining the machining conditions applicable to the machining path selected from the database unit 20. The information output unit 61A may be configured to provide a user interface that allows the user to select and modify any of the data displayed.

The data modification unit 63 replaces the data of the records in the database unit 20, which are specified by the condition commands specifying the machining conditions applicable to the machining path selected by the path selection unit 50, with new data entered by the user. As a result, the machining conditions for all machining paths, to which the same condition commands are applicable, are uniformly modified.

While the embodiments of the present disclosure have been described above, the present invention is not limited to these embodiments. The effects described in the aforementioned embodiments are merely examples of the most advantageous effects achieved by the present invention and are not limited to those disclosed in the aforementioned embodiments.

The numerical control apparatus according to the present invention may be equipped with both a program modification unit and a data modification unit. In this case, a function that enables only one of the program modification unit or the data modification unit may be provided. Alternatively, both the condition commands and the records in the database unit may be displayed to allow for simultaneous editing, and the user's editing actions may allow for determining whether the condition commands should be modified by the program modification unit, or the records in the database unit should be modified by the data modification unit.

### EXPLANATION OF REFERENCE NUMERALS

1, 1a: numerical control apparatus
2: input/output device
10: program storage unit
20: database unit
30: path derivation unit
40: condition specification unit
50: path selection unit
60, 60a: condition modification unit
61, 61a: information output unit
62: program modification unit
63: data modification unit

1. A numerical control apparatus that controls a machining device, based on a machining program including at least one condition command specifying a machining condition and a plurality of movement commands specifying machining points, the apparatus comprising:
a program storage unit that stores the machining program;
a path derivation unit that derives a plurality of machining paths connecting the machining points, from the machining program;
a condition specification unit that specifies the condition command specifying the machining condition applicable to each of the machining paths, from the machining program;
a path selection unit that provides a user interface that allows for selecting the machining paths; and
a condition modification unit that provides a user interface that allows for modifying the machining condition applicable to the machining paths selected in the path selection unit.

2. The numerical control apparatus according to claim 1, wherein the condition modification unit includes a program modification unit that modifies the condition command of the machining program.

3. The numerical control apparatus according to claim 1, further comprising a database unit that stores a plurality of records, each specifying the machining condition, wherein:
the condition command specifies the records in the database unit; and
the condition modification unit includes a data modification unit that modifies data of the records in the database unit.

4. The numerical control apparatus according to claim 1, wherein the path selection unit is configured to display an image of the machining paths and allow for directly selecting the image of the machining paths displayed.

5. The numerical control apparatus according to claim 1, wherein the condition modification unit includes an information output unit that outputs information on the machining condition applicable to the machining paths selected.

6. The numerical control apparatus according to claim 5, wherein the information output unit provides a popup display of information on the machining condition while the path selection unit is displaying the machining paths.
